(19) United States
(12) Patent Application Publication
(10) Pub. No.: US 2012/0089372 A1
(43) Pub. Date: Apr. 12, 2012

(54) APPARATUS AND METHOD FOR ADAPTIVE TIME-FREQUENCY ANALYSIS

(75) Inventors: Sun-Hua Pao, Taipei City (TW); Yio-Wha Shau, Taipei City (TW); Chieh-Neng Young, Tainan City (TW)

(73) Assignee: INDUSTRIAL TECHNOLOGY RESEARCH INSTITUTE, HSINCHU (TW)

(21) Appl. No.: 13/242,471

(22) Filed: Sep. 23, 2011

(30) Foreign Application Priority Data
Oct. 6, 2010 (TW) 99134106

(51) Int. Cl. G06F 19/00

(52) U.S. Cl. 702/190

(57) ABSTRACT

An apparatus and a method for adaptive adaptive time-frequency analysis are suitable for nonlinear and nonstationary signal analyses. The method includes the following steps. A plurality of positions of local extrema of a signal is determined. Average frequencies between the local extrema and mean energy distribution corresponding thereto are estimated according to the positions of the local extrema of the signal. The estimated instantaneous energy distribution of the signal is determined by way of optimization according to each of the mean energy distribution between the local extrema. Finally, an instantaneous frequency of the signal is estimated according to the estimated instantaneous energy distribution of the signal.

This application claims the benefit of Taiwan application Serial No. 99134106, filed Oct. 6, 2010, the subject matter of which is incorporated herein by reference.

### BACKGROUND

1. Technical Field

This disclosed embodiments relate in general to a method and an apparatus for time-frequency analysis, and more particularly to a method and an apparatus for time-frequency analysis for nonlinear and nonstationary signals.

2. Description of the Related Art

Hilbert-Huang Transform (HHT), disclosed by Norden E. Huang et al., is a feasible and effective method for analyzing nonlinear and nonstationary signals. HHT is composed of two main processes. First, an empirical mode decomposition (EMD) is performed on a signal according to a sifting procedure to obtain some intrinsic mode functions (IMFs), which is abbreviated as a mode. Next, the Hilbert transform is performed on each intrinsic mode function to express the signal as a function of time and frequency, and thus to obtain Hilbert amplitude spectrum (or abbreviated as Hilbert spectrum) for the signal, which can represent the amplitude with respect to frequency and time plane in a planar or three-dimensional drawing. In addition, the Hilbert energy spectrum can be obtained according to the square of the amplitude. The analyst can interpret and analyze the nonlinear and nonstationary signals, generated from various phenomena, according to the above-mentioned analysis method.

However, HHT also has critical problems to be solved. For example, the IMF, obtained according to EMD, may lead to the problem of mode mixing and distortion associated with the low frequencies. In other words, the mode mixing may make the intrinsic modes lose their physical meaning. Thus, the occurrence of mode mixing of intrinsic modes could seriously affect the subsequent results represented by the Hilbert spectrum and the correctness of interpretation of the results.

In addition, the conventional Hilbert transform involves data processing based on the fast Fourier transform and the inverse fast Fourier transform to obtain the instantaneous frequency and amplitude at each data point. This is a very time-consuming procedure and is suitable for the applications requiring fast response. Most important of all, the conventional Hilbert transform is done based on assumption that the signal given is linear and stationary. Thus, in either theory or practice, it is not appropriate to apply the Hilbert transform to the real-world signal processing, especially when the signal given is nonlinear.

Research center for adaptive data analysis of National Central University of Taiwan discloses an improvement of Hilbert transform (HT), which is referred to as HT by direct quadrature to satisfy the time-frequency calculation. This approach is currently asserted to be applied to the nonlinear and nonstationary signals and is a numerical method for directly estimating the complete instantaneous energy distribution of the signal. Finally, the instantaneous frequency thereof is estimated using the complete instantaneous energy distribution of the signal. The principle of the estimation is based on the positions and values of local extrema of the signal as control points, without considering the information of other data.

On the other hand, according to the theory of Doppler effect, the frequency of the echo, generated from the reflection of the incident wave on the surface of an object moving at a velocity, is directly proportional to the velocity. Therefore, the Doppler frequency shift is an important signal for performing contactless velocity measurement. To calculate the Doppler frequency shift, the frequency difference between the incident wave and the echo has to be precisely analyzed. Conventionally, the technique for analysis employing FFT technology encounters two problems. The first problem is that the echo is a nonlinear signal, and the second problem is that the echo is a nonstationary signal. These problems result in a poor performance in analysis by Doppler based on the FFT (the time and velocity resolutions are poor).

### SUMMARY

This disclosure is directed to an apparatus and a method for adaptive time-frequency analysis, and is suitable for the processing of the time-frequency analysis of the nonlinear and nonstationary signals.

According to an embodiment, a method for adaptive time-frequency analysis is provided. The method includes the following steps. A plurality of positions of local extrema of a signal is determined. Instantaneous energy distribution of the signal is estimated by an optimization process according to the positions of local extrema and an estimated instantaneous frequency is determined according to the estimated instantaneous energy distribution of the signal.

According to another embodiment, a computer readable medium is provided. When an electronic apparatus loads and executes the computer readable medium, the above-mentioned method can be achieved.

According to an alternative embodiment, an apparatus for adaptive time-frequency analysis is provided. The apparatus includes an input unit, a memory unit, a processing module, and an output unit. The input unit reads a signal. The memory unit stores a data signal of the signal. The processing module determines an estimated instantaneous energy distribution and an estimated instantaneous frequency according to the data signal. The output unit outputs the estimated instantaneous energy distribution and the estimated instantaneous frequency. The processing module determines a plurality of positions of local extrema of the data signal. The processing module determines a plurality of estimated mean frequencies and an estimated mean energy distribution according to the data signal and the positions of local extrema. The processing module determines, by an optimization process, the estimated instantaneous energy distribution and the estimated instantaneous frequency corresponding to the data signal according to the data signal and the estimated mean energy distribution.

According to an alternative embodiment, an apparatus for adaptive time-frequency analysis is provided. The apparatus includes an extremum determining module, a preliminary estimation module, and an optimization estimation module. The extremum determining module is for determining a plurality of positions of local extrema of a signal. The preliminary estimation module determines a plurality of estimated mean frequencies and an estimated mean energy distribution according to the signal and the positions of local extrema. The optimization estimation module determines, by an optimization process, an estimated instantaneous energy distribution and an estimated instantaneous frequency according to the signal and the estimated mean energy distribution.

According to an alternative embodiment, a system for adaptive time-frequency analysis is provided. The system includes a first time-frequency analysis device, a second time-frequency analysis device and a comparing unit. The first time-frequency analysis device determines a plurality of positions of local extrema of a first signal, estimates an instantaneous energy distribution of the signal according to an optimization process, determines an estimated instantaneous frequency of the first signal and determines the instantaneous energy distribution and instantaneous angular velocity information of the first signal. The second time-frequency analysis device determines a plurality of positions of local extrema of a second signal, estimates an instantaneous energy distribution of the second signal according to the optimization process, determines an estimated instantaneous frequency of the second signal, and determines the instantaneous energy distribution and instantaneous angular velocity information of the second signal. The comparing unit determines instantaneous Doppler frequency shifts of the first signal and the second signal according to the instantaneous angular velocity information of the first signal and the second signal.

### BRIEF DESCRIPTION OF THE DRAWINGS

FIG. 1 shows a method for adaptive time-frequency analysis according to a first embodiment.

FIG. 2A shows an example of an intrinsic mode of a signal.

FIGS. 2B and 2C are schematic illustrations respectively showing the determination of the estimated instantaneous frequency and the estimated instantaneous energy based on the intrinsic mode of FIG. 2A according to the first embodiment.

FIG. 2D is a schematic illustration showing the instantaneous energy obtained after the estimated instantaneous energy of FIG. 2C is optimized.

FIG. 3 is a block diagram showing an apparatus 300 for adaptive time-frequency analysis according to an embodiment.

FIG. 4 is a block diagram showing an embodiment serving as a fast Hilbert transform module.

FIG. 5A is a flow chart showing an example of the method for adaptive time-frequency analysis used in a Doppler frequency shift process according to a second embodiment.

FIG. 5B is a block diagram showing an example of a system for adaptive time-frequency analysis according to the method of FIG. 5A.

FIG. 6A is a flow chart showing a second example of the method for adaptive time-frequency analysis used in a Doppler frequency shift process according to the second embodiment.

FIG. 6B is a block diagram showing an example of a system for adaptive time-frequency analysis according to the method of FIG. 6A.

FIG. 7 shows an example of an instantaneous frequency spectrum and an instantaneous energy graph obtained according to the second embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiments of this disclosure are directed to an apparatus and a method for adaptive time-frequency analysis, suitable for the analysis of processing the nonlinear and nonstationary signals. In one embodiment, an apparatus and a method for adaptive time-frequency analysis are disclosed and employed to estimate an instantaneous frequency and an instantaneous energy distribution according to an intrinsic mode of the signal. In another embodiment, the embodiment is applied to the processing of Doppler frequency shift signal to determine the value of desired instantaneous physical quantity. The embodiments can be applied to one-dimensional signals, and may further be extended to multi-dimensional signals. The following embodiments may be implemented by a computer program, a general processor, or a dedicated circuit.

Compared with the HT by direct quadrature, the following embodiments are provided, wherein in addition to the existing control points, other information is considered, and the optimization process is employed to constrain and achieve reasonable, reliable estimation.

### First Embodiment

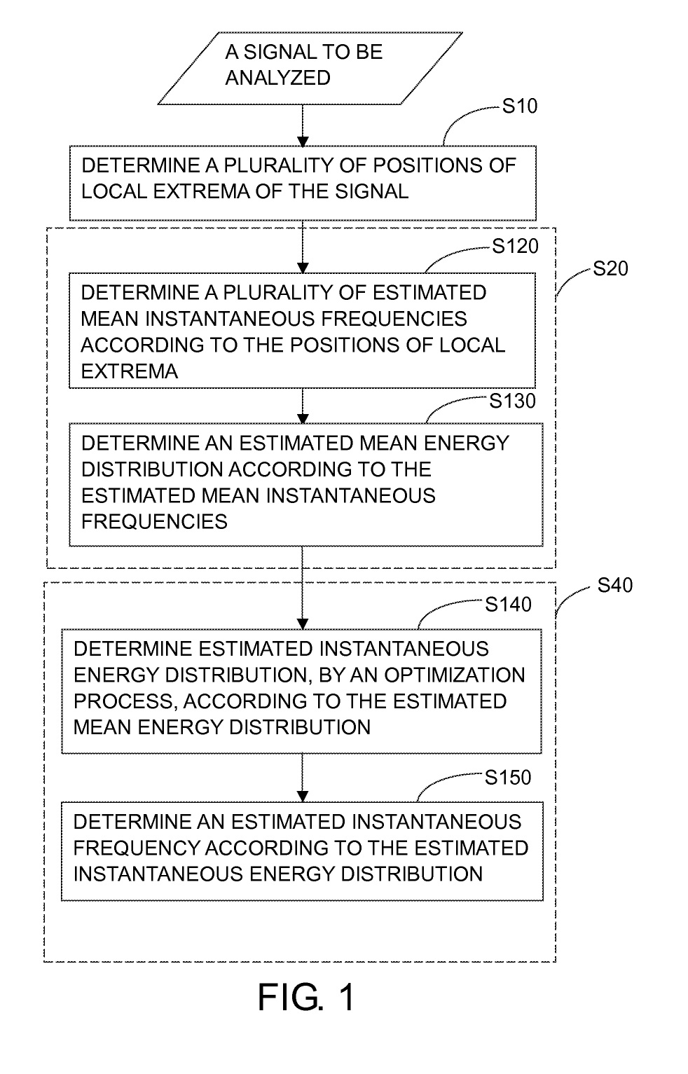

This embodiment discloses an apparatus and a method for adaptive time-frequency analysis to estimate the instantaneous frequency and the instantaneous energy distribution according to a mode (i.e., an intrinsic mode function) of the signal. The method of this embodiment includes the following steps. First, a plurality of positions of local extrema of a signal to be analyzed are determined. Instantaneous energy distribution of the signal is then estimated by an optimization process according to the positions of local extrema, and estimated instantaneous frequency is determined according to the estimated instantaneous energy distribution. FIG. 1 shows a method for adaptive time-frequency analysis according to the first embodiment. In this embodiment, it is assumed that the signal to be analyzed is a signal that is compliant with the requirements for the Hilbert transform. That is, the signal oscillates around a central line (e.g., 0 or mean value of the signal), which also means that the maximum values of this signal are located above the central line and the minimum values of this signal are located below the central line. Since an intrinsic mode of a signal can satisfy the above-mentioned requirements, a mode y(t) of a one-dimensional signal (or data set) will be described for the sake of discussion. In addition, the embodiment may further be extended to the application of the multi-dimensional signal in other embodiments.

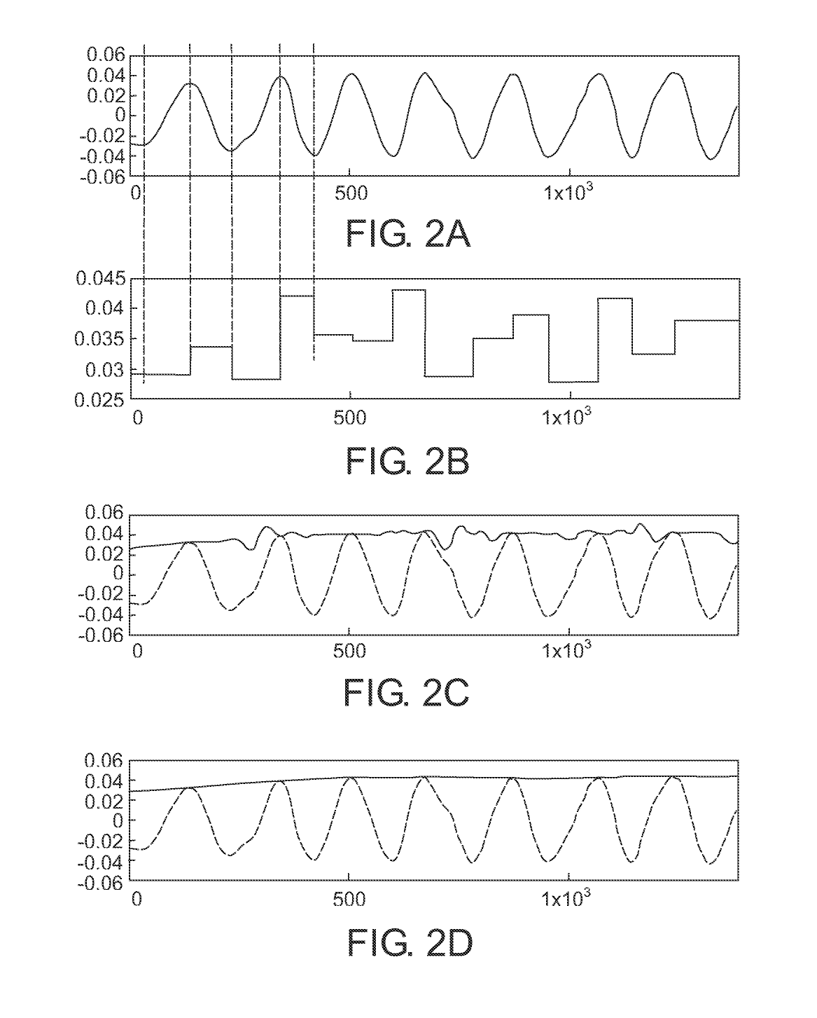

As shown in step S10, the signal to be analyzed is a mode y(t), and a plurality of positions of local extrema of the mode are to be determined. FIG. 2A shows an example of an intrinsic mode of a signal. Referring to FIG. 2A, the maximum values and the minimum values of the mode usually appear in a paired manner. For example, one maximum value is followed by one minimum value and vice versa. In step S10, at the positions of local extrema, the values of time (i.e., the independent variable) of the mode y(t) are determined, such as (Max₀,Min₀), (Max₁,Min₁) . . . (Maxₙ,Minₙ), wherein Max₀ and Min₀ represent the time coordinates of the first set of maximum and minimum values.

According to these positions of local extrema, the instantaneous energy distribution of the signal is estimated by an optimization process, and the estimated instantaneous frequency is determined according to the estimated instantaneous energy distribution. The preliminary estimation and optimization will be exemplified below.

As shown in step S20, the preliminary estimation is to determine a plurality of estimated mean frequencies and estimated mean energy distribution according to the mode and these positions of local extrema, as shown in the sub-steps S120 and S130 for example. In sub-step S120, a plurality of estimated mean instantaneous frequencies are determined according to these positions of local extrema. For example, the mean instantaneous frequencies ω(t) between the local extrema of all the data points of y(t) are roughly estimated according to the view point using the zero-crossing frequency as the mean frequency of y(t). For example, as shown in FIG. 2B, the estimated mean instantaneous frequency between the two time coordinates are determined according to the time coordinates between the neighboring maximum value and minimum value:

$$ω ( t ) = \frac{2 π}{2 ( {Min}_{k} - {Max}_{k} )} = \frac{π}{{Min}_{k} - {Max}_{k}} ,$$

wherein Maxₖ (wave peak)≦t≦Minₖ (wave valley);
or

$$ω ( t ) = \frac{2 π}{2 ( {Max}_{k + 1} - {Min}_{k} )} = \frac{π}{{Max}_{k + 1} - {Min}_{k}} ,$$

wherein Minₖ (wave valley)≦t≦Maxₖ+1 (wave peak). In addition, the determination of the estimated mean instantaneous frequency is not limited thereto. For example, the time coordinates between two neighboring maximum values (or minimum values) may also be regarded as a mean instantaneous period between two neighboring maximum values, or a mean instantaneous period between two neighboring zero-crossing points may also be estimated.

In sub-step S130, the estimated mean energy distribution is determined according to these estimated mean instantaneous frequencies. In FIG. 2C, for example, the solid line represents the estimated mean energy distribution P(t), and the determination method is according to the relationship that the square of P(t) is equal to the sum of the square of the kinetic energy and the square of the potential energy. Thus:

$$P ( t ) = \sqrt{{y ( t )}^{2} + {[ \frac{{y}^{′} ( t )}{ω ( t )} ]}^{2}} ,$$

wherein y′(t) is the differential of y(t), and may be represented by the numerical difference

$${y}^{′} ( t ) = \frac{y ( t + 1 ) - y ( t - 1 )}{2} .$$

As shown in step S40, the estimated instantaneous energy distribution and the estimated instantaneous frequency are determined by an optimization process according to the mode and the estimated mean energy distribution, as shown in sub-steps S140 and S150. In sub-step S140, the estimated instantaneous energy distribution is determined according to the estimated mean energy distribution. The estimated mean energy distribution P(t) is a coarse estimation of the mean energy in the mode y(t) at each time point. In fact, the instantaneous energy Pt(t) is implied in P(t). The instantaneous energy theoretically varies more slowly. Thus, P(t) has to be optimized for the estimation. For example, the rule of the least-square method is utilized to perform the optimization. A simplest embodiment of the least-square method is to optimize the values of piecewise spline interpolation value, as shown in FIG. 2D, wherein the solid line represents the result of the optimization processing, wherein:

$$Pt ( t ) = {\sum }_{t = 0}^{t = N + 1} Spline ( t , t + 1 ) ,$$

and Spline(t,t+1) is the piecewise spline from the data time t to the data time (t+1).

In this step, it is also possible to perform the numerical adjustment according to finite bases, such as the interpolation method with second-order, third-order or higher-order curve. If the multiple-order curve interpolation is adopted, more boundary conditions are needed. The boundary condition may be set by making the curve passing through the extremum points, and making the derivative (e.g., first-order, second-order differential continuity, or the like) of curve seams continuous.

In sub-step S150, the estimated instantaneous frequency is determined according to the estimated instantaneous energy distribution as follows:

$$θ ( t ) = \frac{y ( t )}{Pt ( t )} .$$

In addition, the sub-step S150 may further include: determining the phase angle of y(t) at the time t as φ(t)=cos⁻¹[θ(t)], and the angular velocity angle of y(t) at the time t as

$$Ω ( t ) = \frac{φ ( t + 1 ) - φ ( t - 1 )}{2} .$$

Thus, one signal may be processed according to the above-mentioned steps to determine the corresponding estimated instantaneous energy distribution and estimated instantaneous frequency, and thus to generate the Hilbert amplitude spectrum (or abbreviated Hilbert spectrum) or generate the Hilbert energy spectrum. According to the embodiment, the distribution of the amplitude or energy on the plane of frequency and time of a signal may be presented in a planar or three-dimensional drawing on an output unit, such as a computer, a display of an analyzer, a printer, or a projecting device. According to such presentation, the analyst can interpret or further analyze the nonlinear and nonstationary signals generated by various phenomena. In addition, examples of estimation in other applications will be provided in the following.

In the above embodiment, the preliminary estimation (e.g., steps S120 to S130) is firstly performed and then at least one optimization (e.g., steps S140 to S150) is performed. As such, this embodiment has a reduced complexity and higher efficiency as compared with the conventional Hilbert transform having the complicated procedures based on the fast Fourier transform and the inverse fast Fourier transform. In addition, this embodiment can be further suitable for the parallel processing of a large amount of data. Thus, the above steps of this embodiment may be named as the fast Hilbert transform (FHT). In particular, the fast Hilbert transform can be adapted for analysis of the nonlinear and nonstationary signals, especially the Doppler echo.

The above-mentioned embodiment can be implemented by computer program, and may also be implemented with hardware to increase the efficiency. For example, a general processor, digital signal analyzer, or programmable circuit module (e.g., FGPA) may be used for implementation, or the dedicated circuit may be adopted to implement the above-mentioned method according to the parallel processing or the pipeline architecture.

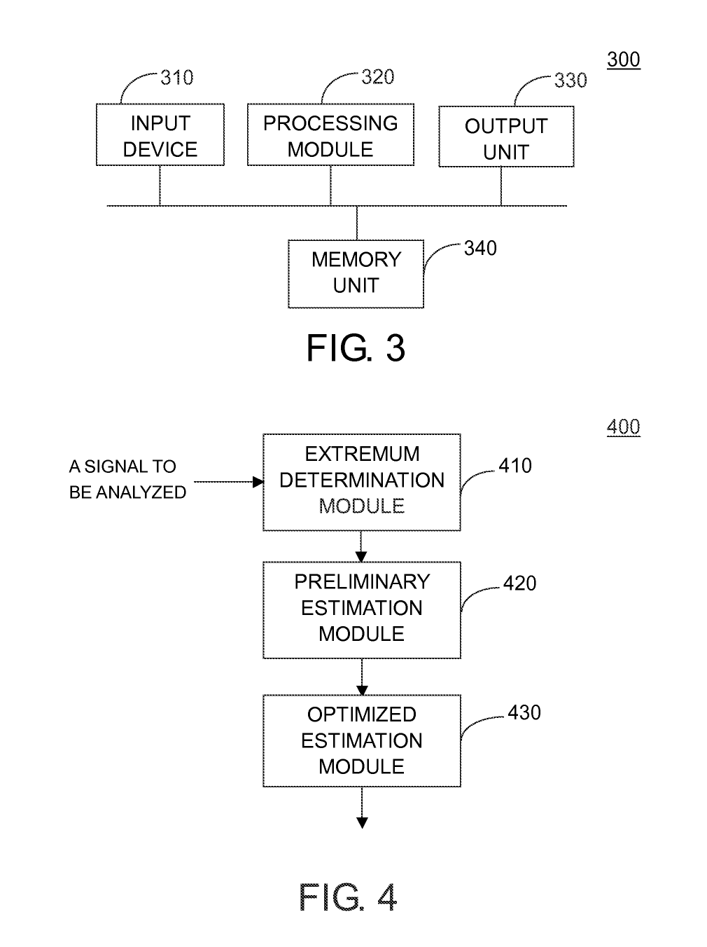

FIG. 3 is a block diagram showing an apparatus 300 for adaptive time-frequency analysis according to an embodiment. Referring to FIG. 3, the apparatus 300, such as a computer system or a signal analyzer, includes an input unit 310, a processing module 320, an output unit 330, and a memory unit 340. The input unit 310 reads the input signal f_{IN}, e.g., a one-dimensional or multi-dimensional signal (or data), or may sense a physical signal, e.g., various waves such as a mechanical wave, an electromagnetic wave, or a Doppler signal. The memory unit 340, e.g., a memory, a hard disk, an optical disk, or any other storage device, stores the input signal f_{IN} as a data signal. The processing module 320, such as a microprocessor, a multi-core microprocessor or array, a digital signal processor, or a field programmable gate array (FPGA) or a dedicated chip, for performing the fast Hilbert transform (FHT) in a manner according to the first embodiment to generate, e.g., the Hilbert spectrum or Hilbert energy spectrum, which is displayed on the display of the output unit 330 or outputted from the output unit 330.

In addition, the output unit 330, e.g., various displays, touch screens, or printing devices, or various data output interfaces, outputs these modes for the analysis of the input signal. Taking the touch screen as an example, the apparatus 300, such as a computer system or a signal analyzer, regards the nonstationary and nonlinear physical signals as the input signal, and the time-frequency analysis is performed on the input signal and then the analysis result is displayed on the screen so that the user can make analysis and observation, e.g., the medicine electrocardiogram or image analysis. In addition, in another example, stored input data, such as a two-dimensional image or one-dimensional or two-dimensional data, may be read from the input unit 310 for the HTT-EMD or H-EMD processing. In one example, it is possible to control the associated mode decomposing operation and to set the associated parameters or conditions through the touch screen or input interface.

FIG. 4 is a block diagram showing another embodiment of a fast Hilbert transform module 400. Referring to FIG. 4, the fast Hilbert transform module 400 adopts, for example, a linear structure, and includes an extremum determining module 410, a preliminary estimation module 420, and an optimization estimation module 430. In some embodiments, the modules of the fast Hilbert transform module 400 respectively implement the method of FIG. 1 of the first embodiment by way of hardware, e.g., the digital circuits such as an adder, a multiplier, a divider, or a register, or any other logic circuits, a microprocessor or a FPGA. In addition, in other embodiments, the fast Hilbert transform module 400 may also serve as an independent module, or may be combined and linked with other hardware for HHT-EMD-based mode decomposition to achieve the Hilbert spectrum analysis.

In addition to the embodiments of FIGS. 3 and 4, modification of the method of FIG. 1 or implementation with the hardware configuration different from that of FIG. 1 can also be achieved by one skilled in the art based on the FHT for performing a preliminary estimation and at least one optimized estimation according to the mode. For example, the FHT may be implemented using pipeline or by parallel processing circuitry.

### Second Embodiment

This embodiment proposes a system and a method for adaptive time-frequency analysis. This embodiment is achieved based on the first embodiment, and is further applied to the extraction and analysis of the physical signal, e.g., the processing of detecting the Doppler frequency shift of minor blood flow. This embodiment provides two methods.

### First Method

The Doppler analysis, for example, is the key principle in the biomedical equipment for measuring the blood flow. The operational principle is to mix the transmitted signal with the echo signal to obtain a mixed signal, and a band pass filter is employed to extract the Doppler information from the mixed signal. When an object has the radial movement, the object reflects an incident wave at a frequency fₒ and the frequency (f) of the reflected wave is changed by Δf, wherein Δf=f−f₀. Δf is referred to as a Doppler frequency shift, which may be a positive or a negative value for representing that the object is moved forwards or backwards. It is a challenge for the Doppler signal processing to detect the objects, such as the erythrocytes in the blood, with the slow velocity. The slower flowing velocity generates the smaller Doppler frequency shift. In addition, if the reflected energy is small, the signal processing becomes more difficult.

As mentioned hereinabove, the transmitted signal and the echo signal are mixed to generate a mixed signal. The so-called signal mixing is to carry out a convolution operation on the transmitted signal (Ro) and the echo (Rref), and may be represented as: F(t)=Ro(t)×Rref(t+δ). For the sake of illustration, a simple mathematical model will be illustrated as an example. If Ro=A(t) cos (2πf₀t) and Rref=B(t) cos [2π(f+Δf)t] are established, then:

F(t)=A(t)*B(t)*[cos (4πf₀t)+cos (2πΔft)],

wherein cos (4πf₀t) is the high-frequency item carrying the transmitted signal frequency, cos (2πΔf t) is the low-frequency item carrying the Doppler shift information, which is the desired signal to be extracted.

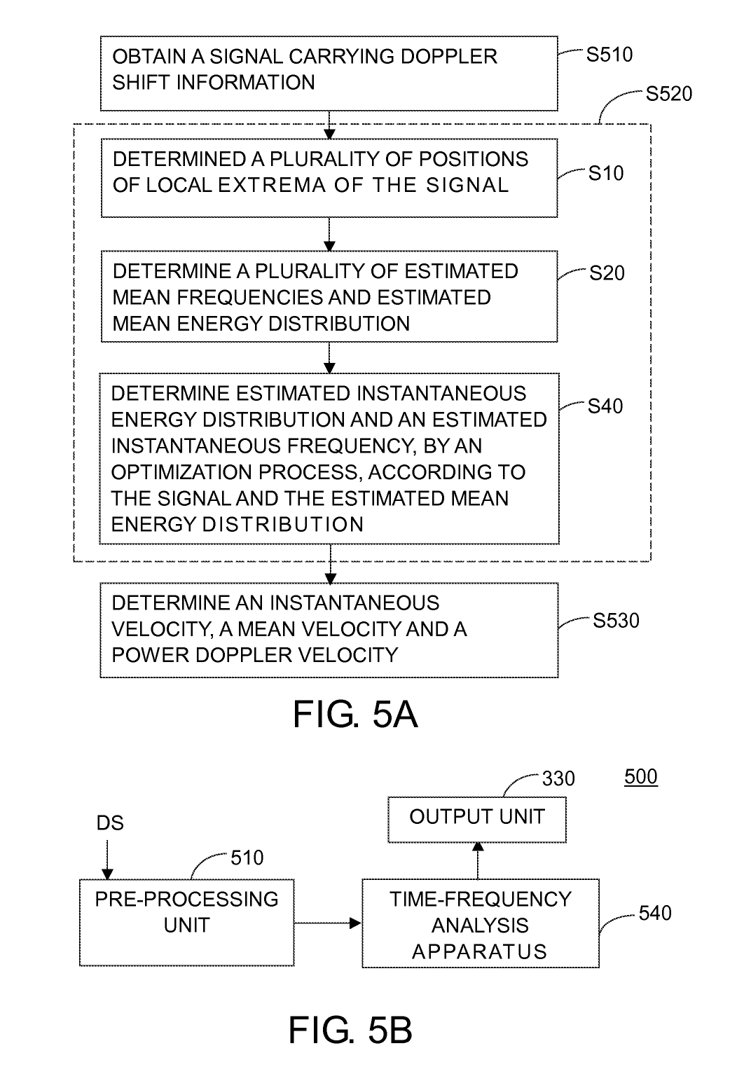

FIG. 5A is a flow chart showing an example of the method for adaptive time-frequency analysis used in a Doppler frequency shift process according to a second embodiment. As shown in step S510, a signal carrying the Doppler shift information, e.g., a flow velocity signal of an object, is obtained. For example, conventional adaptive filtering, such as the HHT EMD or the hierarchical EMD, is used to perform the mode decomposition on the mixed signal to obtain a plurality of modes, which include the high-frequency components, the low-frequency components and the residual. In another example, wavelet analysis may be adopted to obtain the modes. In other examples, if the obtained signal carrying the Doppler shift information satisfies the requirements for the Hilbert analysis, such as the low-frequency component, the mode decomposition is optional.

Next, as shown in step S520, the signal carrying the Doppler shift information is processed to obtain estimated instantaneous energy distribution Power(t) and estimated instantaneous frequency Δf(t). In an exemplary embodiment, the processing is done by the fast Hilbert transform, as shown in the steps S10, S20 and S40 of FIG. 1, to determine the corresponding estimated instantaneous energy distribution and estimated instantaneous frequency. In another embodiment, the conventional Hilbert transform or other computation methods may also be employed to obtain the estimated instantaneous energy distribution and the estimated instantaneous frequency.

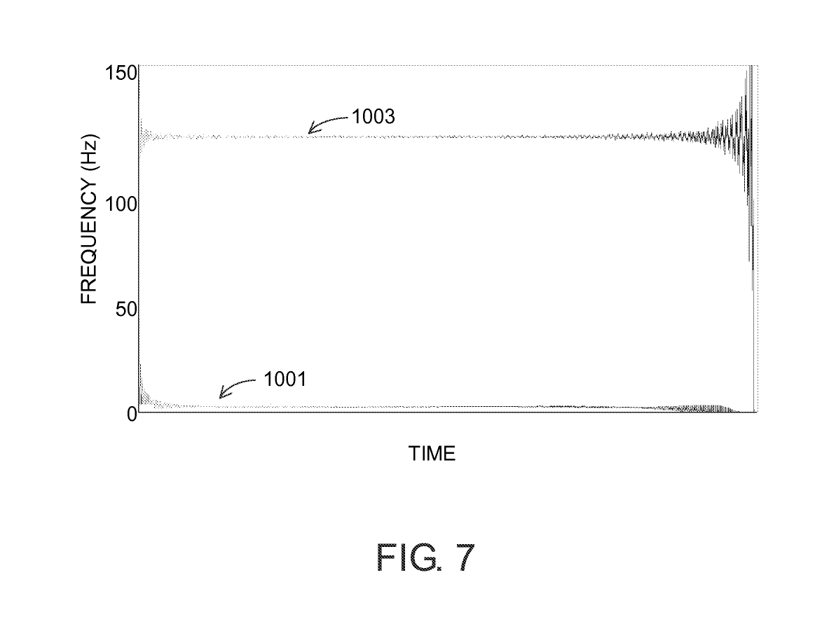

FIG. 7 shows an example of the instantaneous energy distribution Power(t) and the estimated instantaneous frequency Δf(t), wherein 1001 represents the low-frequency component of the Doppler signal and 1003 represents the high-frequency component of the transmitted signal. According to this drawing, it is obtained that the low frequency noise (residual value component) does not exist in the instantaneous frequency spectrum because it has been automatically filtered out. As can observed, the details of the Doppler frequency shift signal can be represented at any time instant. The conventional approach of mean frequency spectrum energy technology using the FFT filter cannot achieve such results. With the details of the Doppler frequency shift signal at any time instant, the instantaneous velocity, the mean velocity or the power Doppler velocity of this object can be calculated, as shown in step S530. For example, the associated definitions are defined in the following:

Instantaneous velocity:

v=0.5*Δf(t)*C/f₀;

Mean velocity:

vₘₑₐₙ=0.5*Δfₘₑₐₙ*C/fₒ, wherein mean frequency shift Δfₘₑₐₙ=Σ[Δf(t)dt]/T;

and
Power Doppler velocity:

v_{pd}=Σ[0.5*Δf(t)*Power(t)*C/fₒdt]/T.

In addition, if the transmitted signal in the above-mentioned example is a pulsed wave at a velocity C, then its waveform is not necessarily to be the cosine wave, and its frequency is not necessarily to be the narrowband. The echo carries the signal attenuation and noise, so the mixing cannot be handled easily. Basically, the processing of F(t) is to perform the decomposition according to one of the above-mentioned mode decomposition methods. The flow velocity is v=0.5*Δf*C/fₒ, and the positioning resolution is x=C*T. In addition, if the low-frequency component only has ¼λ, the analysis cannot be made unless the pulsed duration T is extended to at least 1λ. If the low-frequency component only has 2λ, then the analysis can be made, and the frequency shift is Δf=2/T Hz. Thus, if the effective Δf has to be measured, then the pulse length needs to be T>k/Δf sec, wherein k>=1.

In addition, in step S510, the low-frequency component carries the Doppler shift information, but the signal actually is not the same as the above simple mathematical model with the carrier wave only. In brief, the low frequency component still has a certain bandwidth, so the frequency bands have to be weighted to obtain the mean according to the above-mentioned equation when the velocity measurement value is determined in step S530.

As shown in FIG. 5B, an apparatus for adaptive time-frequency analysis is for use in the detection of the Doppler frequency shift processing of the minor blood flow, for example. Referring to FIG. 5B, the adaptive time-frequency analysis system 500 includes a pre-processing unit 510, a time-frequency analysis apparatus 540, and an output unit 330.

The pre-processing unit 510 performs the appropriate processing before the signal analysis, and compensates the signal to make the inputted signal DS satisfy the requirements for the Hilbert transform. For example, the pre-processing unit 510 includes an amplifier and an analog-to-digital converter. In another example, the pre-processing unit 510 may be implemented as selectively having the mode decomposing function, and when the inputted signal DS does not satisfy the Hilbert transform condition, the signal can be adaptively filtered (e.g., the mode decomposition may be performed on the signal). For example, when the inputted signal, such as the mixed signal, is the digital signal, the pre-processing unit 510 of this example is used to decompose the signal into the high-frequency component and the low-frequency component, which are then outputted to the time-frequency analysis apparatus 540.

The time-frequency analysis apparatus 540 realizes the time-frequency analysis of the signal so as to implement steps S520 and S530. The time-frequency analysis apparatus 540 may be implemented in a manner similar to that of the processing module 320 or 400 of the first embodiment, and may further be otherwise implemented by, for example, the digital signal processor or any other circuit. In other examples, the time-frequency analysis system 500 may further include a computing device for implementing step S530. In addition, the time-frequency analysis apparatus 540 may also be implemented as selectively having the mode decomposing function to perform the mode decomposition and the time-frequency analysis on the inputted signal according to the manner of the adaptive filter, such as HHT-EMD. In addition, the system 500 may also be implemented based on the adaptive time-frequency analysis apparatus 300 of the first embodiment.

For example, if the adaptive time-frequency analysis system 500 is applied to the ultrasonic Doppler frequency shift analysis, it may further include an ultrasonic unit (not shown) for transmitting an ultrasonic wave as the transmitted signal and receiving the echo signal. For example, the ultrasonic unit includes the ultrasonic emitting element and the ultrasonic receiving element. The system 500 may include an echo signal mixing module (not shown) for generating a mixed signal according to the transmitted signal and the echo signal. For example, the echo signal mixing module includes the digital or analog circuitry for performing the mixing.

### Second Method

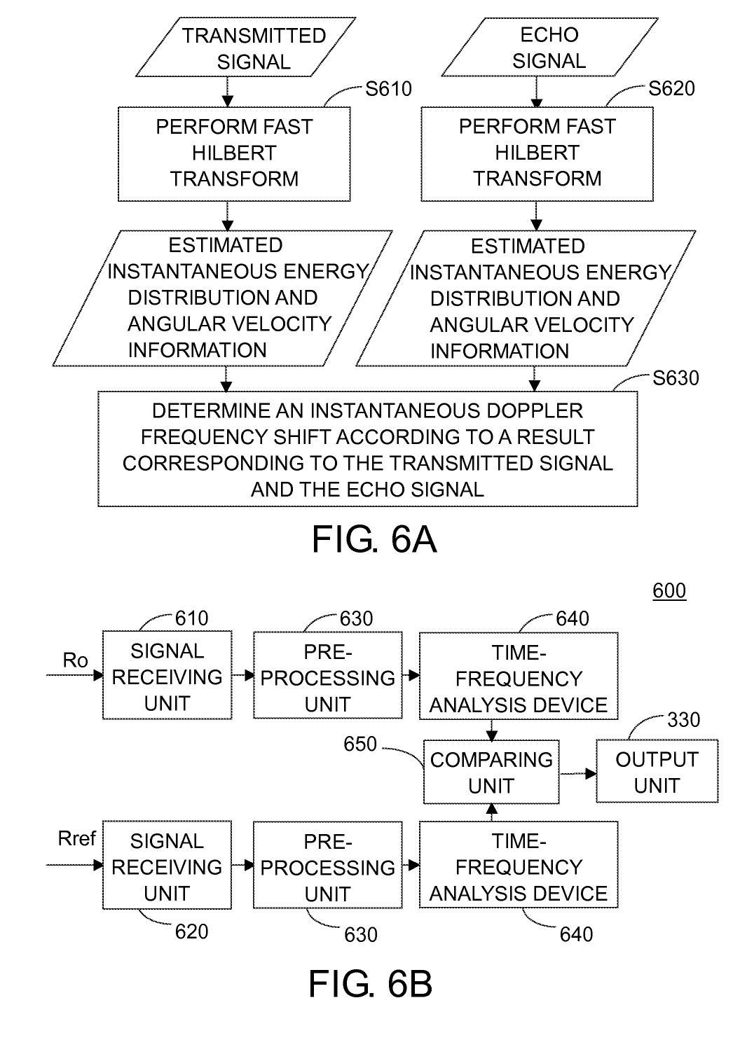

FIG. 6A is a flow chart showing a second example of the method for adaptive time-frequency analysis used in a Doppler frequency shift process according to the second embodiment. As shown in FIG. 6A, the difference between the second method and the first method resides in that the second method directly performs the time-frequency analysis on the transmitted signal and the echo signal.

As shown in steps S610 and S620, the fast Hilbert transforms are respectively performed on the transmitted signal, such as Ro=A(t) cos (2πf₀ t), and the echo, such as Rref=B(t) cos [2π(f+Δf)t], for example, in a manner as that of the first embodiment. Thus, the transmitted signal Ro(t) can be decomposed into the instantaneous energy distribution A(t) and the angular velocity information Ωo(t). The echo (Rref) can be decomposed into the instantaneous energy distribution B(t) and the angular velocity information Ωref(t).

Next, as shown in step S630, the instantaneous Doppler frequency shift is determined according to the above result corresponding to the transmitted signal and the echo signal. Thus, according to the above-mentioned example, the Doppler frequency shift at the moment t is, for example, Δf(t)=[Ωref(t)−Ωo(t)]/2π.

FIG. 6B shows an adaptive time-frequency analysis system 600, which can be suitable for the processing of the detection of the Doppler frequency shift, and can implement the method of FIG. 6A. As shown FIG. 6B, the adaptive time-frequency analysis system 600 includes signal receiving units 610 and 620, corresponding pre-processing units 630 and time-frequency analysis devices 640, a comparing unit 650 and an output unit 330. The signal receiving units 610 and 620 respectively receive the transmitted signal and the echo signal, digitize the transmitted signal and the echo signal, and record the digitized transmitted signal and echo signal. Each of the two pre-processing units 630 is similar to the pre-processing unit 510 of FIG. 5B. Next, the time-frequency analysis device 640 is similar to the time-frequency analysis device 540 of FIG. 5B and is used to implement steps S610 and S620 of FIG. 6A. The comparing unit 650 processes the results from the two time-frequency analysis devices 640 to implement step S630. Finally, the adaptive time-frequency analysis system 600 further utilizes the output unit 330 to output or present the result of the Doppler frequency shift. Similar to the example of FIG. 5B, the above-mentioned units and devices may have various implementations. In other examples, the pre-processing unit 630 of FIG. 6B and the corresponding time-frequency analysis device 640 may be combined into an apparatus. In addition, the signal receiving unit 610 and the corresponding pre-processing unit 630 may also be regarded as one unit. In this case, the implementation is not restricted to that of FIG. 6B. Any modification is still deemed as falling within the scope of the embodiment as long as the two time-frequency analysis devices 640 are utilized and the results thereof are utilized to implement the process of step S630. In addition, the adaptive time-frequency analysis system 600 may also be implemented in another manner by, for example, the parallel processor.

The system and the method for the adaptive time-frequency analysis using the HHT-EMD and FHT may further be applied to the pulsed Doppler, color Doppler, power Doppler, tissue Doppler and the like in other embodiments. Furthermore, since this method has the advantage of adaptability, in some embodiments, the time gain control (TGC) of the reflected wave can be effectively compensated, the nonlinear attenuation of the signal can be eliminated, and the interference can be adaptively eliminated (i.e., adaptive wall filter).

In addition, HHT-EMD advantageously has the lower distortion than the conventional filter in the low frequency signal. According to the minor blood flow measurement of this embodiment, this embodiment can further extend the application of ultrasonic techniques to the important applications such as the cancer metastasis and detection, the detection of the peripheral artery disease (e.g., diabetes), the detection of the liver function, and the like. It is certain that the above-mentioned embodiments are not limited to the ultrasonic Doppler frequency shift analysis. Those skilled in the art may extend the applications to the time-frequency analyses of other waves, such as the mechanical wave, the electromagnetic wave, and the like.

Furthermore, other embodiments further disclose a computer or computing device readable information storage medium for storing program code or one or multiple program modules. The program code may be executed to implement the method for adaptive time-frequency analysis in FIG. 1, 5A or 6A. The readable information storage medium in each of the embodiments can be exemplified as, without limitation to, an optical information storage medium, a magnetic information storage medium, or a memory, such as a memory card, firmware, ROM or RAM.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for adaptive time-frequency analysis, the method comprising:
(a) determining a plurality of positions of local extrema of a signal; and
(b) estimating instantaneous energy distribution of the signal by an optimization process according to the positions of local extrema, and determining an estimated instantaneous frequency according to the estimated instantaneous energy distribution of the signal.

2. The method according to claim 1, wherein the optimization process is a least-square method.

3. The method according to claim 2, wherein the least-square method is performed using values of optimized piecewise spline interpolation with a second-order, a third-order or a higher order curve.

4. The method according to claim 1, wherein the step (b) comprises:
determining a plurality of estimated mean instantaneous frequencies according to the positions of local extrema; and
determining estimated mean energy distribution according to the estimated mean instantaneous frequencies.

5. The method according to claim 4, wherein the estimated mean instantaneous frequencies are determined based on the positions of local extrema, according to a zero-crossing frequency definition.

6. The method according to claim 5, wherein the estimated mean energy distribution is determined according to the signal and the estimated mean instantaneous frequencies.

7. The method according to claim 4, wherein the step (b) further comprises:
determining the estimated instantaneous energy distribution according to the estimated mean energy distribution through the optimization process; and
determining the estimated instantaneous frequency according to the estimated instantaneous energy distribution.

8. The method according to claim 7, wherein the estimated instantaneous frequency is determined according to the signal and the estimated instantaneous energy distribution.

9. The method according to claim 1, wherein the signal has Doppler shift information, and the method further comprises:
determining at least one of parameters including an instantaneous velocity, a mean velocity and a power Doppler velocity, according to the instantaneous energy distribution and the estimated instantaneous frequency.

10. The method according to claim 9, wherein the signal is an intrinsic mode of a mixed signal.

11. The method according to claim 1, wherein the signal is a signal of an echo, and the method further comprises:
(c) determining instantaneous energy distribution and instantaneous angular velocity information of the echo according to the instantaneous energy distribution and the estimated instantaneous frequency.

12. The method according to claim 11, further comprising:
(a1) determining a plurality of positions of local extrema of a transmitted signal;
(b1) estimating, by an optimization process, instantaneous energy distribution of the signal of the emitted wave according to the positions of local extrema, and determining the estimated instantaneous frequency according to the estimated instantaneous energy distribution of the transmitted signal;
(c1) determining the instantaneous energy distribution and the instantaneous angular velocity information of the emitted wave based on the instantaneous energy distribution and the estimated instantaneous frequency obtained in the step (b1) according to the transmitted signal; and
(d) determining an instantaneous Doppler frequency shift according to the emitted wave and the instantaneous angular velocity information of the echo.

13. A computer readable medium, wherein the method according to claim 1 can be achieved when an electronic apparatus loads and executes the computer readable medium.

14. An apparatus for adaptive time-frequency analysis, the apparatus comprising:
an input unit for reading a signal;
a memory unit for storing a data signal of the signal;
a processing module for determining an estimated instantaneous energy distribution and an estimated instantaneous frequency according to the data signal; and
an output unit for outputting the estimated instantaneous energy distribution and the estimated instantaneous frequency;
wherein the processing module determines a plurality of positions of local extrema of the data signal;
the processing module determines a plurality of estimated mean frequencies and an estimated mean energy distribution according to the data signal and the positions of local extrema; and
the processing module determines, by an optimization process, the estimated instantaneous energy distribution and the estimated instantaneous frequency corresponding to the data signal according to the data signal and the estimated mean energy distribution.

15. The apparatus according to claim 14, wherein the signal has Doppler shift information, and the processing module further determines an instantaneous velocity, a mean velocity and a power Doppler velocity according to the instantaneous energy distribution and the estimated instantaneous frequency.

16. The apparatus according to claim 15, wherein the signal is an intrinsic mode of a mixed signal.

17. The apparatus according to claim 14, wherein the signal is a signal of an echo, and the processing module further determines instantaneous energy distribution and instantaneous angular velocity information of the echo according to the instantaneous energy distribution and the estimated instantaneous frequency.

18. The apparatus according to claim 17, wherein the processing module further:
determines a plurality of positions of local extrema of a signal of an emitted wave based on the transmitted signal;
estimates, by an optimization process, an instantaneous energy distribution of the transmitted signal according to the positions of local extrema;
determines the estimated instantaneous frequency according to the estimated instantaneous energy distribution of the transmitted signal;
determines the instantaneous energy distribution and the instantaneous angular velocity information of the emitted wave based on the instantaneous energy distribution and the estimated instantaneous frequency obtained according to the transmitted signal; and
determining an instantaneous Doppler frequency shift according to the instantaneous angular velocity information of the transmitted wave and the echo.

19. An apparatus for adaptive time-frequency analysis, the apparatus comprising:
an extremum determining module for determining a plurality of positions of local extrema of a signal;
a preliminary estimation module for determining a plurality of estimated mean frequencies and an estimated mean energy distribution according to the signal and the positions of local extrema; and
an optimization estimation module for determining, by an optimization process, an estimated instantaneous energy distribution and an estimated instantaneous frequency according to the signal and the estimated mean energy distribution.

20. The apparatus according to claim 19, wherein the estimated mean instantaneous frequencies are determined according to the positions of local extrema based on a zero-crossing frequency definition.

21. The apparatus according to claim 20, wherein the estimated mean energy distribution is determined according to the signal and the estimated mean instantaneous frequencies.

22. The apparatus according to claim 19, wherein the estimated instantaneous energy distribution is determined according to the estimated mean energy distribution using a least-square method.

23. The apparatus according to claim 22, wherein the estimated instantaneous frequency is determined according to the signal and the estimated instantaneous energy distribution.

24. A system for adaptive time-frequency analysis, the system comprising:
a first time-frequency analysis device for determining a plurality of positions of local extrema of a first signal, estimating an instantaneous energy distribution of the signal according to an optimization process, determining an estimated instantaneous frequency of the first signal and determining the instantaneous energy distribution and instantaneous angular velocity information of the first signal;
a second time-frequency analysis device for determining a plurality of positions of local extrema of a second signal, estimating an instantaneous energy distribution of the second signal according to the optimization process, determining an estimated instantaneous frequency of the second signal, and determining the instantaneous energy distribution and instantaneous angular velocity information of the second signal; and
a comparing unit for determining instantaneous Doppler frequency shifts of the first signal and the second signal according to the instantaneous angular velocity information of the first signal and the second signal.

25. The system according to claim 24, wherein the optimization process is a least-square method.

26. The system according to claim 25, wherein the least-square method is performed using values of optimized piecewise spline interpolation with a second-order, third-order or higher-order curve.

27. A method for analyzing a flow velocity signal of an object, the method comprising:
(a) obtaining the signal carrying Doppler shift information;
(b) processing the signal to determine a corresponding estimated instantaneous energy distribution and an estimated instantaneous frequency of the signal; and
(c) calculating an instantaneous velocity, a mean velocity, or a power Doppler velocity of the object according to the estimated instantaneous energy distribution and the estimated instantaneous frequency.

28. The method according to claim 27, wherein the step (b) is processed by a fast Hilbert transform to determine the estimated instantaneous energy distribution and the estimated instantaneous frequency corresponding to each other.

29. The method according to claim 27, wherein the step (b) is processed by a Hilbert transform to determine the corresponding estimated instantaneous energy distribution and the estimated instantaneous frequency of the signal.

30. The method according to claim 28, wherein the fast Hilbert transform further comprises:
(b1) determining a plurality of positions of local extrema of the signal;
(b2) determining a plurality of estimated mean frequencies and an estimated mean energy distribution according to the positions of local extrema; and
(b3) determining, by an optimization process, the estimated instantaneous energy distribution and the estimated instantaneous frequency according to the signal and the estimated mean energy distribution.

31. The method according to claim 30, wherein the optimization process is a least-square method, and the least-square method is performed using optimized values of piecewise spline interpolation with a second-order, third-order or higher-order curve.
